(19) United States
(12) Patent Application Publication
(10) Pub. No.: US 2021/0167622 A1
(43) Pub. Date: Jun. 3, 2021

(54) CHARGING METHOD AND DEVICE, TERMINAL DEVICE AND STORAGE MEDIUM

(71) Applicant: BEIJING XIAOMI MOBILE SOFTWARE CO., LTD., Beijing (CN)

(72) Inventors: Zhenhuan XU, Beijing (CN); Jinhu ZHANG, Beijing (CN)

(73) Assignee: BEIJING XIAOMI MOBILE SOFTWARE CO., LTD., Beijing (CN)

(21) Appl. No.: 16/915,923

(22) Filed: Jun. 29, 2020

(30) Foreign Application Priority Data
Dec. 3, 2019 (CN) 201911222058.X

(51) Int. Cl. H02J 7/00

(52) U.S. Cl. CPC H02J 7/007192; H02J 7/0047

(57) ABSTRACT

Provided are a charging method and device, a terminal device and a storage medium. The method includes: detecting a temperature and a temperature variation trend parameter of a terminal device, the temperature variation trend parameter including a temperature variation direction and/or a temperature variation rate; determining a charging strategy for the terminal device based on the temperature and/or the temperature variation trend parameter, the charging strategy at least including a charging mode and the charging mode including a constant current charging mode and/or a constant voltage charging mode; and charging the terminal device according to the charging strategy.

### CROSS-REFERENCE TO RELATED APPLICATION

This application is based upon and claims priority to Chinese Patent Application No. 201911222058.X filed on Dec. 3, 2019, the entire contents of which are incorporated herein by reference for all purposes.

### TECHNICAL FIELD

The present disclosure generally relates to the technical field of charging, and more particularly, to a charging method and device, a terminal device and a storage medium.

### BACKGROUND

Along with gradual development of terminal devices such as mobile phones, functions of mobile phones have been increasingly enriched and power consumption of the mobile phones has also increased, often bringing a phenomenon that a mobile phone is needed to be used for a game or work, etc. while the mobile phone is still charged in use of the mobile phone. Therefore, for reducing the phenomenon that a mobile phone is used while being charged, a charging speed of the mobile phone is needed to be increased. At present, a charging speed of a mobile phone is usually increased by increasing a charging current. However, increase of the charging current may bring heating of the mobile phone, intensification of battery polarization.

### SUMMARY

The present disclosure provides a charging method and device, a terminal device and a storage medium.

According to a first aspect of the present disclosure, a charging method may include following acts: a temperature and temperature variation trend parameter of a terminal device are detected, the temperature variation trend parameter including a temperature variation direction and/or a temperature variation rate; a charging strategy for the terminal device is determined based on the temperature and/or the temperature variation trend parameter, the charging strategy at least including a charging mode and the charging mode including a constant current charging mode and/or a constant voltage charging mode; and the terminal device is charged according to the charging strategy.

According to a second aspect of the present disclosure, a charging device may include: a processor; and a memory configured to store instructions executable by the processor. The processor being configured to: obtain a temperature and a temperature variation trend parameter of a terminal device, the temperature variation trend parameter including a temperature variation direction and/or a temperature variation rate; determine a charging strategy for the terminal device based on the temperature and/or the temperature variation trend parameter, the charging strategy at least including a charging mode and the charging mode including a constant current charging mode and/or a constant voltage charging mode; and instruct the terminal device to charge according to the charging strategy.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a first flowchart showing a charging method according to an embodiment of the present disclosure.

FIG. 2 is a second flowchart showing a charging method according to an embodiment of the present disclosure.

FIG. 3 is a third flowchart showing a charging method according to an embodiment of the present disclosure.

FIG. 4 is a fourth flowchart showing a charging method according to an embodiment of the present disclosure.

FIG. 5 is a fifth flowchart showing a charging method according to an embodiment of the present disclosure.

FIG. 6 is a sixth flowchart showing a charging method according to an embodiment of the present disclosure.

FIG. 7 is a seventh flowchart showing a charging method according to an embodiment of the present disclosure.

FIG. 8 is a diagram of a charging device according to an exemplary embodiment.

FIG. 9 is a physical structure diagram of a terminal device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” and the like may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

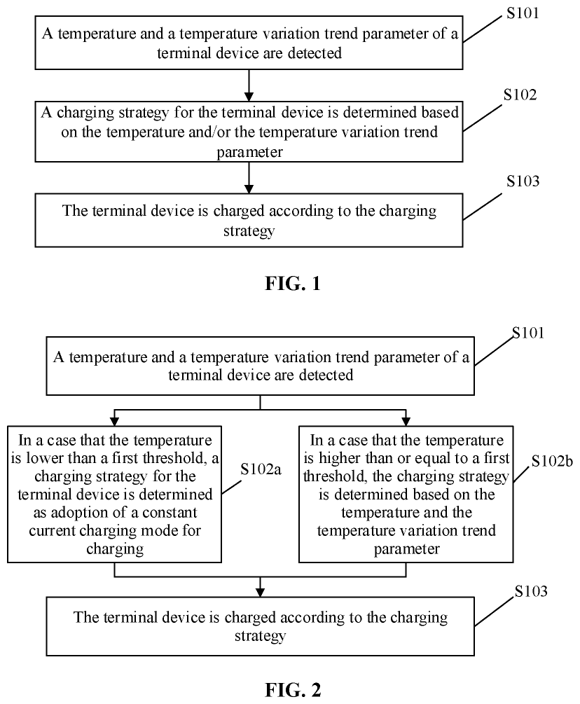

FIG. 1 is a first flowchart showing a charging method according to an embodiment of the present disclosure. As shown in FIG. 1, the method applied to a terminal device includes the following operations.

In S101, a temperature and a temperature variation trend parameter of the terminal device are detected, the temperature variation trend parameter including a temperature variation direction and/or a temperature variation rate.

In S102, a charging strategy for the terminal device is determined based on the temperature and/or the temperature variation trend parameter, the charging strategy at least including a charging mode and the charging mode including a constant current charging mode and/or a constant voltage charging mode.

In S103, the terminal device is charged according to the charging strategy.

The terminal device may be a terminal device supporting different charging modes, where the terminal device includes a function module in a working state. The terminal device may be a wearable electronic device or a mobile terminal. The mobile terminal may include a mobile phone, a notebook computer and a tablet computer, and the wearable electronic device may include a smart watch. There are no limits made in some embodiments.

The function module may include, but not limited to, an audio module configured to output an audio signal, a display module configured to display information or a processing module configured to process information. The case that the function module is in the working state may include that the audio output module is outputting an audio signal and/or the display module is displaying information and/or the processing module is processing information.

In some embodiments, the temperature of the terminal device may reflect a bulk temperature of the terminal device, and the bulk temperature of the terminal device may be a weighted average temperature determined through temperatures measured at different parts of the terminal device and each weight corresponding to each temperature. It is to be noted that the terminal device may include temperature sensors in at least two parts. For example, a first temperature sensor may be arranged at a battery of the terminal device, and a second temperature sensor may be arranged at a mainboard of the terminal device. That is, in some embodiments, the temperature of the terminal device may be detected through temperatures detected by the at least two temperature sensors of the terminal device and a weight corresponding to each temperature.

In an example, the bulk temperature T of the terminal device may be determined by formula (1), where T1, T2 T3 and T4 are temperatures detected by temperature sensors at four different parts of the terminal device, X1, X2, X3 and X4 are weights corresponding to the temperatures at different parts respectively, and X1+X2+X3+X4=100%.

T=T1/X1+T2/X2+T3/X3+T4/X4 (1).

It is to be noted that the temperature sensor may include, but not limited to, a negative temperature coefficient (NTC) thermistor or a positive temperature coefficient (PTC) thermistor. In a practical process of determining a temperature of the terminal device, the temperature of the terminal device may be detected at an interval of a first preset time period. The first preset time period may be set according to a practical requirement. For example, the first preset time period may be set as 0.5 s.

In some embodiments, the temperature variation trend parameter may include the temperature variation direction and/or the temperature variation rate. The temperature variation direction may include an upward temperature variation direction and a downward temperature variation direction. The temperature variation rate may reflect fast/slow temperature variation of the terminal device. Fast/slow temperature variation may be determined through a temperature variation speed and a temperature variation acceleration.

In an example, the temperature variation speed T′ may be determined by formula (2), and the temperature variation acceleration T″ may be determined by formula (3), where Δt is a time difference, and ΔT′ is a temperature variation speed difference:

$$\begin{matrix}{T}^{′} - \frac{T 2 - T 1}{Δ t} , and & ( 2 ) \\ {T}^{″} = \frac{Δ {T}^{′}}{Δ t} . & ( 3 )\end{matrix}$$

It is to be noted that, in a practical process of charging a terminal device, the temperature variation speed T′ and the temperature variation acceleration T″ may be determined according to a practical requirement. For example, the temperature variation speed T′ may be determined after charging for 1 s, and the temperature variation acceleration T″ may be determined after charging for 1.5 s. There are no limits made In some embodiments.

In some embodiments, the terminal device may determine the charging strategy for the terminal device according to the temperature and the temperature variation trend parameter or may also determine the charging strategy for the terminal device according to the temperature. There are no limits made in the disclosure.

It is to be noted that the charging strategy may at least include a constant current charging mode and/or a constant voltage charging mode. The constant current charging mode is configured to represent a charging mode that a charging current is kept constant during charging. The constant voltage charging mode is configured to represent a charging mode that a charging voltage is kept constant during charging. Since the terminal device is limited by a battery capacity and/or internal resistance, the charging current of the terminal device is kept constant but the charging voltage may be gradually increased when the constant current charging mode is adopted for charging; and when the constant voltage charging mode is adopted for charging, the charging voltage of the terminal device is kept constant but the charging current may be gradually decreased.

In some embodiments, the charging strategy may further include a charging parameter corresponding to the charging mode.

That is, when a present charging mode is the constant current charging mode, the charging strategy may further include a constant current charging parameter corresponding to the constant current charging mode; and when the present charging mode is the constant voltage charging mode, the charging strategy may further include a constant voltage charging parameter corresponding to the constant voltage charging mode.

It is to be noted that, in the charging process of the terminal device, power consumption of the terminal device may keep varying, accompanied by dynamic variation of the temperature of the terminal device. For example, the temperature of the terminal device may be increased under the condition that the power consumption of the terminal device is increased. Therefore, when the power consumption of the terminal device is increased, the temperature of the terminal device may be usually decreased by limiting the charging current. However, directly reducing the charging current to a limited charging current may increase the polarization internal resistance of the battery and further prolong a charging time.

In view of this, it is proposed in some embodiments that the charging strategy for the terminal device may be determined based on the temperature and/or the temperature variation trend parameter and the terminal device may be charged based on the charging strategy. That is, according to the embodiments of the present disclosure, the charging strategy may be determined directly based on the temperature of the terminal device and fast/slow temperature variation reflected by the temperature variation rate, and fast/slow temperature variation may reflect present power consumption of the terminal device. Therefore, according to the embodiments of the present disclosure, the charging strategy may be dynamically adjusted based on present power consumption of the terminal device on the premise of effectively controlling the temperature of the terminal device to further accelerate charging of the terminal device.

In some embodiments, as shown in FIG. 2, the operation that the charging strategy for the terminal device is determined based on the temperature and/or the temperature variation trend parameter, i.e., S102, includes the following operations.

In S102a, in a case that the temperature is lower than a first threshold, the charging strategy for the terminal device is determined as adoption of the constant current charging mode for charging.

In S102b, in a case that the temperature is higher than or equal to a first threshold, the charging strategy is determined based on the temperature and the temperature variation trend parameter.

The first preset threshold may be set according to a practical user requirement. For example, the first threshold may be set as a preset temperature value such as 37° C. or 36° C. There are no limits made in some embodiments.

In some embodiments, the temperature of the terminal device may directly impact the charging strategy for the terminal device. When the temperature is lower than the first threshold, for example, when the temperature is lower than 37° C., the impact from the increase of power consumption of the terminal device on the temperature of the terminal device may not impact user perception, so that constant current charging may be directly performed on the terminal device through a maximum charging current to rapidly increase the charging voltage of the terminal device and further increase a charging speed of the terminal device.

The condition that the temperature of the terminal device is higher than or equal to the first threshold, for example, the temperature is higher than 37° C., may be caused by increase of the power consumption of the terminal device. When the power consumption of the terminal device is getting higher, the terminal device may generate great heat due to the high power consumption and thus increase the temperature of the terminal device. When the temperature of the terminal device is getting higher, continuation of heavy current charging may cause charging cooling by charging internal resistance of the terminal device and thus further increase the temperature of the terminal device, thereby making overheating of the terminal device perceivable for a user or causing performance reduction or disorder of the terminal device because of overheating. In some embodiments, if the temperature is higher than or equal to the first threshold, the charging strategy may further be determined according to the temperature and the temperature variation trend parameter to ensure that the temperature of the terminal device may be timely adjusted and reduce the condition that the temperature of the terminal device is suddenly increased.

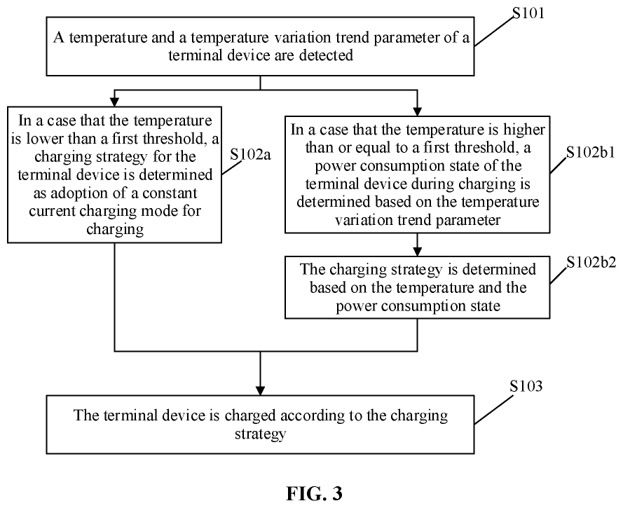

In some embodiments, as shown in FIG. 3, the operation that the charging strategy is determined based on the temperature and the temperature variation trend parameter, i.e., S102b, includes the following operations.

In S102b1, a power consumption state of the terminal device during charging is determined based on the temperature variation trend parameter.

In S102b2, the charging strategy is determined based on the temperature and the power consumption state.

In some embodiments, the temperature variation direction and temperature variation rate of the terminal device may reflect a present power consumption state of the terminal device. When the temperature of the terminal device varies upwards and the temperature variation rate keeps increasing, it may be determined that the present power consumption of the terminal device is continuously increased. When the temperature of the terminal device varies downwards and the temperature variation rate is kept unchanged, it may be determined that the present power consumption of the terminal device is continuously decreased.

In some embodiments, the operation that the power consumption state of the terminal device during charging is determined based on the temperature variation trend parameter includes that:

in response to the temperature variation rate in the temperature variation trend parameter increasing at a first rate, it is determined that the power consumption state of the terminal device during charging is a first power consumption state;

in response to the temperature variation rate in the temperature variation trend parameter increasing at a second rate, it is determined that the power consumption state of the terminal device during charging is a second power consumption state; and

in response to the temperature variation rate in the temperature variation trend parameter increasing at a third rate, it is determined that the power consumption state of the terminal device during charging is a third power consumption state.

In some embodiments, the second rate may be lower than the first rate, and power consumption of the terminal device in the second power consumption state may be lower than power consumption in the first power consumption state; and the third rate may be lower than the second rate, and power consumption of the terminal device in the third power consumption state may be lower than the power consumption in the second power consumption state.

That is, the temperature variation rate of the terminal device may be positively related to the power consumption of the terminal device during charging, and if the temperature variation rate of the terminal device is higher, the power consumption of the terminal device during charging may be higher. It is apparent that the size of the temperature variation rate may impact the power consumption of the terminal device and further impact the temperature variation of the terminal device.

In an example, the temperature variation rate in the temperature variation trend parameter may be determined to be increased at the first rate by determining that the temperature variation speed is higher than A and the temperature variation acceleration is higher than B.

In some embodiments, the temperature variation rate in the temperature variation trend parameter may be determined to be increased at the second rate by determining that the temperature variation speed is higher than 0 and lower than A and the temperature variation acceleration is lower than B.

In some embodiments, the temperature variation rate in the temperature variation trend parameter may be determined to be increased at the third rate by determining that the temperature variation speed is lower than 0 and the temperature variation acceleration is higher than 0.

A and B may be set according to a practical requirement. A may be set as 0.4° C./s (degrees centigrade per second), and B may be set to be 0.32° C./s² (degrees centigrade per second squared). There are no limits made in the disclosure.

It is to be noted that, when both the power consumption and temperature of the terminal device are high, charging the terminal device with the maximum charging current may increase the battery polarization internal resistance of the terminal device, prolong the charging time and further make the temperature of the terminal device excessively high to impact use of the terminal device by a user and normal work of components in the terminal device. According to the embodiments of the present disclosure, the charging strategy may be determined based on the temperature and the power consumption state, so that the charging strategy may be dynamically adjusted based on the present power consumption of the terminal device on the premise of effectively controlling the temperature of the terminal device to further ensure that the adjusted charging strategy may effectively balance the temperature and charging time of the terminal device to increase the charging speed.

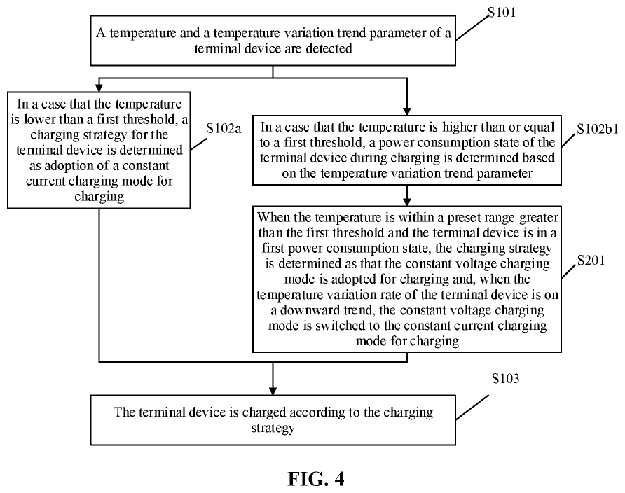

In some embodiments, as shown in FIG. 4, the operation that the charging strategy is determined based on the temperature and the power consumption state may include the following operation.

In S201, when the temperature is within a preset range greater than the first threshold and the terminal device is in the first power consumption state, the charging strategy may be determined as that the constant voltage charging mode is adopted for charging and, when the temperature variation rate of the terminal device is on a downward trend, the constant voltage charging mode is switched to the constant current charging mode for charging.

The preset range greater than the first threshold may be set according to the first threshold. For example, when the first threshold is 37° C., the preset range may be set to be 37° C. to 38° C. When the first threshold is 36° C., the preset range may be set to be 36° C. to 38° C. There are no limits made in the disclosure.

In some embodiments, when the terminal device is at a temperature in the preset range greater than the first threshold and in the first power consumption state, it may be indicated that the temperature of the terminal device is increased at a high speed, and in such case, the terminal device may be switched to the constant voltage charging mode to decrease the charging current to further decrease the temperature increase speed.

It is to be noted that, when the terminal device is switched to the constant voltage charging mode for charging, the charging voltage in the present charging mode may be detected and constant voltage charging may be performed based on the charging voltage in the present charging mode.

According to the embodiments of the present disclosure, the constant voltage charging mode may be switched to the constant current charging mode for charging when the temperature variation rate of the terminal device is on a downward trend under the constant voltage charging mode for charging. That is, when it is detected that temperature variation of the terminal device slows down, a present charging current may be acquired for constant current charging to increase the charging speed.

In an example, when the temperature variation speed of the terminal device is close to 0 and the temperature variation speed is lower than 0, the present charging current of the terminal device may be acquired and constant current charging may be performed based on the present charging current.

According to some embodiments, on the first aspect, the constant current charging mode may be switched to the constant voltage charging mode when the temperature is increased too fast, so that battery polarization may be effectively reduced to shorten the charging time; on the second aspect, the charging current may be decreased in response to the constant current charging mode being switched to the constant voltage charging mode, so that the temperature of the terminal device may be effectively decreased; and on the third aspect, when the temperature variation rate decreases, the constant voltage charging mode may be switched back to the constant current charging mode, so that the charging mode may be timely adjusted on the premise of effectively stabilizing the temperature of the terminal device, and the charging speed may be increased.

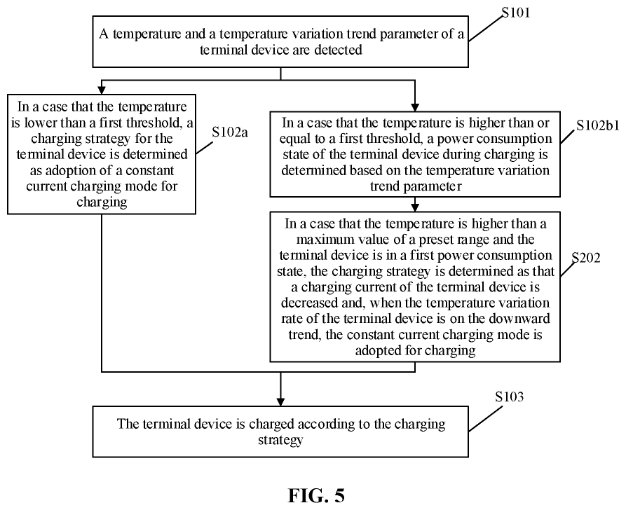

In some embodiments, as shown in FIG. 5, the operation that the charging strategy is determined based on the temperature and the power consumption state may include the following operation.

In S202, in a case that the temperature is higher than a maximum value of the preset range and the terminal device is in the first power consumption state, the charging strategy is determined as that a charging current of the terminal device is decreased and, when the temperature variation rate of the terminal device is on the downward trend, the constant current charging mode is adopted for charging.

The maximum value may be set according to the preset range. For example, when the preset range is 37° C. to 38° C., the maximum value of the preset range is 38° C. When the preset range is 36° C. to 37° C., the maximum value of the preset range is 37° C. There are no limits made in the disclosure.

In some embodiments, when the terminal device is at a temperature higher than the maximum value of the preset range and in the first power consumption state, the temperature of the terminal device may be increased too fast, and in such case, handover to the constant voltage charging mode to decrease the charging current cannot effectively slow down temperature increase, and it is necessary to directly decrease the present charging current of the terminal device.

It is to be noted that the operation that the present charging current of the terminal device is decreased may include that the present charging current of the terminal device is decreased through a preset function.

In an example, the preset function V(t) is formula (4), where K1 and K2 are charging coefficients and may be determined according to a power delivery (PD) protocol or a quick charge (QC) protocol, t is time, and Vm is the charging voltage before decrease:

$$V ( t ) = Vm - K 1 \times t - \frac{K 2}{t 2} . \qquad ( 4 )$$

According to the embodiments of the present disclosure, the charging mode may be switched to the constant current charging mode for charging when the temperature variation rate of the terminal device is on the downward trend after the charging voltage is decreased. That is, when it is detected that temperature variation of the terminal device slows down, constant current charging may be performed according to the present charging current to increase the charging rate.

In an example, when the temperature variation speed of the terminal device is close to 0 and the temperature variation speed is lower than 0, the present charging current of the terminal device may be acquired and constant current charging may be performed based on the present charging current.

According to the embodiments of the present disclosure, on one aspect, the charging current may be continuously decreased, so that the temperature of the terminal device may be effectively decreased; and on the other aspect, after the charging current is continuously decreased, the charging mode may be switched back to the constant current charging mode, so that the charging mode may be timely adjusted on the premise of effectively stabilizing the temperature of the terminal device, and the charging speed may be increased.

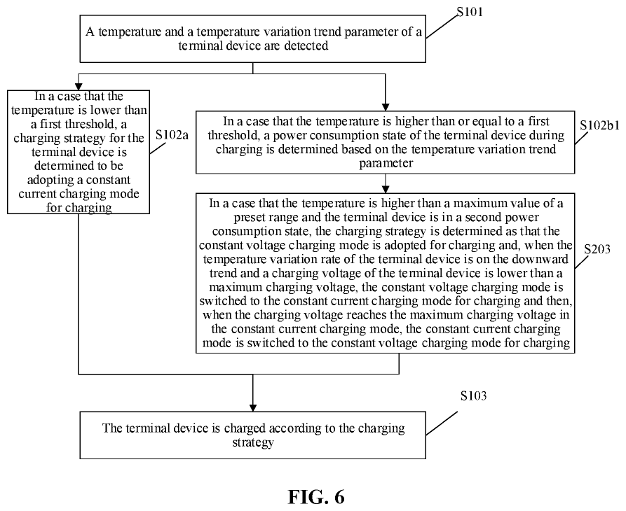

In some embodiments, as shown in FIG. 6, the operation that the charging strategy is determined based on the temperature and the power consumption state may include the following operation.

In S203, in a case that the temperature is higher than a maximum value of the preset range and the terminal device is in the second power consumption state, the charging strategy is determined as that the constant voltage charging mode is adopted for charging and, when the temperature variation rate of the terminal device is on the downward trend and a charging voltage of the terminal device is lower than a maximum charging voltage, the constant voltage charging mode is switched to the constant current charging mode for charging and then, when the charging voltage reaches the maximum charging voltage in the constant current charging mode, the constant current charging mode is switched to the constant voltage charging mode for charging.

In some embodiments, when the terminal device is at a temperature higher than the maximum value of the preset range and is in the second power consumption state, the temperature of the terminal device may be increased at a relatively high speed, and in such case, the terminal device may be switched to the constant voltage charging mode to decrease the charging current to further decrease the temperature increase speed.

It is to be noted that, when the temperature variation rate of the terminal device is on the downward trend under the constant voltage charging mode for charging and the charging voltage of the terminal device is lower than the maximum charging voltage, the charging mode may be switched to the constant current charging mode for charging and, when the charging voltage reaches the maximum charging voltage under the constant current charging mode for charging, the charging mode may be switched to the constant voltage charging mode for charging. That is, when it is detected that temperature variation of the terminal device slows down, the present charging current may be acquired for constant current charging to increase the charging rate.

In an example, when the temperature variation speed of the terminal device is close to 0, the present charging current of the terminal device may be acquired and constant current charging may be performed based on the present charging current.

According to the embodiments, on the first aspect, the charging mode may be switched to the constant voltage charging mode when the temperature is increased too fast, so that the charging current may be decreased, and the battery polarization condition may be effectively reduced to shorten the charging time; on the second aspect, the charging current may be decreased when the charging mode is switched to the constant voltage charging mode, so that the temperature of the terminal device may be effectively decreased; and on the third aspect, when the temperature variation rate decreases, the charging mode may be switched back to the constant current charging mode, so that the charging mode may be timely adjusted on the premise of effectively stabilizing the temperature of the terminal device, and the charging speed may be increased.

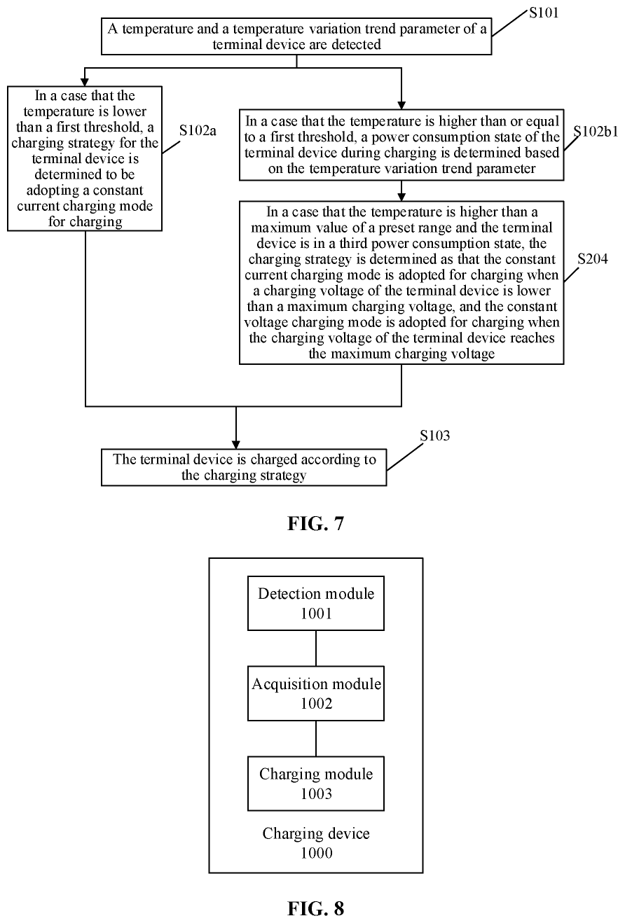

In an example, as shown in FIG. 7, the operation that the charging strategy is determined based on the temperature and the power consumption state may include the following operation.

In S204, in a case that the temperature is higher than the maximum value of the preset range and the terminal device is in the third power consumption state, the charging strategy is determined as that the constant current charging mode is adopted for charging when a charging voltage of the terminal device is lower than a maximum charging voltage, and the constant voltage charging mode is adopted for charging when the charging voltage of the terminal device reaches the maximum charging voltage.

The maximum charging voltage may be a limited charging voltage of the terminal device.

In some embodiments, when the terminal device is at a temperature higher than the maximum value of the preset range and in the third power consumption state, the temperature increase speed of the terminal device may decrease, and in such case, constant current charging may be performed on the terminal device through the maximum charging current to increase the charging speed.

According to some embodiments, on one aspect, when the terminal device is in the third power consumption state, the constant current charging mode may be adopted and then the constant voltage charging mode may be adopted, so that battery polarization may be effectively reduced to shorten the charging time; and on the other aspect, the charging mode may be timely adjusted on the premise of effectively stabilizing the temperature of the terminal device, and the charging speed may be increased.

Some embodiments also provide the following example.

The embodiments of the present disclosure mainly involve a constant current constant voltage control circuit and a temperature detection system. The constant current constant voltage control circuit is configured to switch a charging strategy for a terminal device, for example, switching a constant voltage charging mode to a constant current charging mode or switching the constant current charging mode to the constant voltage charging mode. The temperature detection system is configured to detect temperatures at different parts of the terminal device such that a temperature of the terminal device, a temperature variation speed of the terminal device and a temperature variation acceleration of the terminal device may be determined.

After the terminal device, for example, a mobile phone, is connected with a charger in use, different charging strategies may be formulated for the terminal device according to conditions in combination with the temperature and a power consumption state: when the mobile phone is in a first power consumption state and the temperature ranges from 37° C. to 38° C., the terminal device may be switched to the constant voltage charging mode; and when the mobile phone is in the first power consumption state and the temperature is further increased to over 38° C., a charging current may be controlled to be continuously decreased through a preset function to effectively decrease the temperature of the mobile phone. When the temperature of the mobile phone is lower than 38° C., the constant voltage charging mode and the constant current charging mode may be adjusted in real time according to the temperature and the power consumption state to finally make the mobile phone between 37° C. and 39° C. and ensure a highest charging speed under different power consumption.

In an example, a charging process of the terminal device, for example, the mobile phone, may be dynamically adjusted according to the bulk temperature (T) and the power consumption state through the following operations.

In operation A, when the temperature (T) of the terminal device is lower than 37° C., constant current charging may be performed on the terminal device with a maximum charging current (Imax), and the temperature (T), temperature variation speed (T′), temperature variation acceleration (T″), charging voltage (Vbat), and charging current (Ibat) of the terminal device may be obtained in real time.

In operation B, in case of 37° C.<temperature (T)<38° C., temperature variation speed (T′)>A and temperature variation acceleration (T″)>B, the temperature of the mobile phone may be increased at a high speed, constant voltage charging may be performed with the charging voltage (Vbat), and the charging current (Ibat) may be decreased; and in case of temperature variation speed (T)≈0 and temperature variation acceleration (T″)<0, the present charging current (Ibat) may be selected for constant current charging.

In operation C, if power consumption of the mobile phone is continuously increased to inertially increase the temperature to be 38° C.<temperature (T)<39° C., there are the following conditions:

in case of temperature variation speed (T′)>a and temperature variation acceleration (T″)>b, the preset function may be introduced to continuously decrease the charging current, and in case of temperature variation speed (T′)≈0 and temperature variation acceleration (T″)<0, the present charging current (Ibat) may be selected for constant current charging; and

in case of 0<temperature variation speed (T′)<A and temperature variation acceleration (T″)<B, temperature increase of the mobile phone may slow down, constant voltage charging may be performed based on the presently read charging voltage (Vbat), and the charging current may be decreased; in case of temperature variation speed (T)≈0 and charging voltage (Vbat)<limited charging voltage (Vmax), the present charging current (Ibat) may be selected for continuous constant current charging, and after the charging voltage (Vbat) reaches the limited charging voltage (Vmax), the charging mode may be switched to constant voltage charging; and

in case of temperature variation speed (T)<0, temperature variation acceleration (T″)>0 and charging voltage (Vbat)<limited charging voltage (Vmax), the charging current (Imax) may be set to be the maximum charging current (Imax) for constant current charging, and if the charging voltage (Vbat) reaches the limited charging voltage (Vmax), the charging mode may be switched to constant voltage charging.

According to some embodiments, on the first aspect, the charging strategy and the charging parameter corresponding to the charging strategy may be dynamically adjusted based on the temperature and temperature variation trend parameter of the terminal device to ensure that the temperature mobile phone may still be kept in the interval of 38° C. to 39° C. in the charging process of the mobile phone in a variable power consumption usage scenario, so that a user experience is improved; on the second aspect, constant voltage charging for a short period of time may be introduced without triggering an alarm limit, so that a temperature increase trend may be reduced, battery polarization may be reduced, and the battery charging speed may be increased; and on the third aspect, after the temperature of the terminal device is instantaneously increased, the preset function is introduced to dynamically adjust the charging current, so that the charging current and temperature variation may be effectively balanced to ensure that the terminal device may be adjusted to a proper current for charging on the premise of a stable temperature to increase the charging speed.

FIG. 8 is a diagram of a charging device according to an exemplary embodiment. Referring to FIG. 8, the charging device 1000 includes a detection module 1001, an acquisition module 1002 and a charging module 1003.

The detection module 1001 is configured to detect a temperature and a temperature variation trend parameter of a terminal device, the temperature variation trend parameter including a temperature variation direction and/or a temperature variation rate.

The acquisition module 1002 is configured to determine a charging strategy for the terminal device based on the temperature and/or the temperature variation trend parameter, the charging strategy at least including a charging mode and the charging mode including a constant current charging mode and/or a constant voltage charging mode.

The charging module 1003 is configured to charge the terminal device according to the charging strategy.

In some embodiments, the acquisition module may include:

a first acquisition module, configured to, in response to determining that the temperature is lower than a first threshold, determine the charging strategy for the terminal device as adoption of the constant current charging mode for charging; and

a second acquisition module, configured to, in response to determining that the temperature is higher than or equal to a first threshold, determine the charging strategy based on the temperature and the temperature variation trend parameter.

In some embodiments, the second acquisition module may include:

a third acquisition module, configured to determine a power consumption state of the terminal device during charging based on the temperature variation trend parameter; and

a fourth acquisition module, configured to determine the charging strategy based on the temperature and the power consumption state.

In some embodiments, the third acquisition module may be specifically configured to, in response to the temperature variation rate in the temperature variation trend parameter increasing at a first rate, determine that the power consumption state of the terminal device during charging is a first power consumption state,

in response to the temperature variation rate in the temperature variation trend parameter increasing at a second rate, determine that the power consumption state of the terminal device during charging is a second power consumption state, the second rate being lower than the first rate and power consumption of the terminal device in the second power consumption state being lower than power consumption in the first power consumption state, and

in response to the temperature variation rate in the temperature variation trend parameter increasing at a third rate, determine that the power consumption state of the terminal device during charging is a third power consumption state, the third rate being lower than the second rate and power consumption of the terminal device in the third power consumption state being lower than the power consumption in the second power consumption state.

In some embodiments, the fourth acquisition module may be specifically configured to, when the temperature is within a preset range greater than the first threshold and the terminal device is in the first power consumption state, determine the charging strategy as that the constant voltage charging mode is adopted for charging and, when the temperature variation rate of the terminal device is on a downward trend, the constant voltage charging mode is switched to the constant current charging mode for charging.

In some embodiments, the fourth acquisition module may be specifically configured to, in response to determining that the temperature is higher than a maximum value of the preset range and the terminal device is in the first power consumption state, determine the charging strategy as that a charging current of the terminal device is decreased and, when the temperature variation rate of the terminal device is on the downward trend, the constant current charging mode is adopted for charging.

In some embodiments, the fourth acquisition module may be specifically configured to, in response to determining that the temperature is higher than a maximum value of the preset range and the terminal device is in the second power consumption state, determine the charging strategy as that the constant voltage charging mode is adopted for charging and, when the temperature variation rate of the terminal device is on the downward trend and a charging voltage of the terminal device is lower than a maximum charging voltage, the constant voltage charging mode is switched to the constant current charging mode for charging and then, when the charging voltage reaches the maximum charging voltage in the constant current charging mode, the constant current charging mode is switched to the constant voltage charging mode for charging.

In some embodiments, the fourth acquisition module may be specifically configured to, in response to determining that the temperature is higher than a maximum value of the preset range and the terminal device is in the third power consumption state, determine the charging strategy as that the constant current charging mode is adopted for charging when a charging voltage of the terminal device is lower than a maximum charging voltage, and the constant voltage charging mode is adopted for charging when the charging voltage of the terminal device reaches the maximum charging voltage.

In some embodiments, the charging strategy may further include a charging parameter corresponding to the charging mode.

With respect to the device in the above embodiment, the specific manners for performing operations for individual modules therein have been described in detail in the embodiment regarding the method, which will not be elaborated herein.

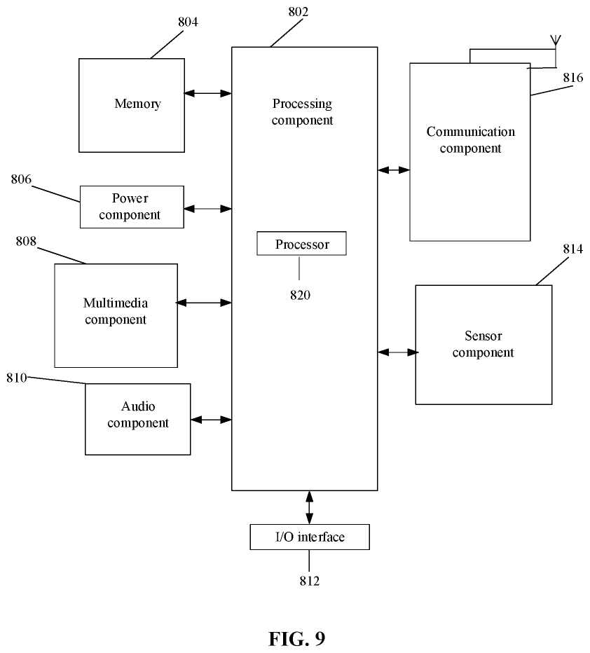

FIG. 9 is a physical structure diagram of a terminal device according to an exemplary embodiment. For example, the terminal device 800 may be a mobile phone and a mobile computer.

The terminal device may include one or more of the following components: a processing component 802, a memory 804, a power component 806, a multimedia component 808, an audio component 810, an Input/Output (I/O) interface 812, a sensor component 814, and a communication component 816.

The processing component 802 is typically configured to control overall operations of the terminal device, such as the operations associated with display, telephone calls, data communications, camera operations, and recording operations. The processing component 802 may include one or more processors 820 to execute instructions to perform all or part of the operations in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the device. Examples of such data include instructions for any application programs or methods operated on the terminal device, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 may provide power for various components of the terminal device. The power component 806 may include a power management system, one or more power supplies, and other components associated with generation, management and distribution of power for the terminal device.

The multimedia component 808 may include a screen providing an output interface between the terminal device and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 808 includes a front camera and/or a rear camera. The front camera and/or the rear camera may receive external multimedia data when the device is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the terminal device is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 may provide an interface between the processing component 802 and a peripheral interface module, and the peripheral interface module may be a keyboard, a click wheel, a button and the like. The button may include, but not limited to: a home button, a volume button, a starting button and a locking button.

The sensor component 814 may include one or more sensors configured to provide status assessment in various aspects for the terminal device. For instance, the sensor component 814 may detect an on/off status of the device and relative positioning of components, such as a display and small keyboard of the terminal device, and the sensor component 814 may further detect a change in a position of the terminal device or a component of the terminal device, presence or absence of contact between the user and the terminal device, orientation or acceleration/deceleration of the terminal device and a change in temperature of the terminal device. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the terminal device and another device. The terminal device may access a communication-standard-based wireless network, such as a Wireless Fidelity (Wi-Fi) network, a 2nd-Generation (2G) or 3rd-Generation (3G) network or a combination thereof. In some embodiments, the communication component 816 receives a broadcast signal or broadcast associated information from an external broadcast management system through a broadcast channel. In some embodiments, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology and another technology.

In some embodiments, the terminal device may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In some embodiments, there is also provided a non-transitory computer-readable storage medium including instructions, such as the memory 804 including instructions, and the instructions may be executed by the processor 820 of the terminal device to implement the abovementioned method. For example, the non-transitory computer-readable storage medium may be a ROM, a Random Access Memory (RAM), a Compact Disc Read-Only Memory (CD-ROM), a magnetic tape, a floppy disc, an optical data storage device and the like.

According to a non-transitory computer-readable storage medium, instructions in the storage medium may be executed by at least one processor of a terminal device to enable the terminal device to implement a charging method, the method including:

obtaining a temperature and a temperature variation trend parameter of the terminal device, the temperature variation trend parameter including a temperature variation direction and/or a temperature variation rate;

determining a charging strategy for the terminal device based on the temperature and/or the temperature variation trend parameter, the charging strategy at least including a charging mode and the charging mode including a constant current charging mode and/or a constant voltage charging mode; and

instructing the terminal device to charge according to the charging strategy.

The present disclosure may include dedicated hardware implementations such as application specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the apparatus or system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

Other implementation solutions of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A charging method, comprising:
detecting, by a terminal device supporting different charging modes, a temperature and a temperature variation trend parameter of the terminal device, where the temperature variation trend parameter comprises at least one of a temperature variation direction or a temperature variation rate;
determining, by the terminal device, a charging strategy for the terminal device based on at least one of the temperature or the temperature variation trend parameter, where the charging strategy comprises a charging mode, and the charging mode comprises at least one of a constant current charging mode or a constant voltage charging mode; and
charging the terminal device according to the charging strategy.

2. The charging method of claim 1, wherein determining the charging strategy for the terminal device based on at least one of the temperature or the temperature variation trend parameter comprises:
in response to determining that the temperature is lower than a first threshold, determining the charging strategy for the terminal device as adoption of the constant current charging mode for charging; or
in response to determining that the temperature is higher than or equal to the first threshold, determining the charging strategy based on the temperature and the temperature variation trend parameter.

3. The charging method of claim 2, wherein determining the charging strategy based on the temperature and the temperature variation trend parameter comprises:
determining a power consumption state of the terminal device during charging based on the temperature variation trend parameter; and
determining the charging strategy based on the temperature and the power consumption state.

4. The charging method of claim 3, wherein determining the power consumption state of the terminal device during charging based on the temperature variation trend parameter comprises:
in response to the temperature variation rate in the temperature variation trend parameter increasing at a first rate, determining that the power consumption state of the terminal device during charging is a first power consumption state;
in response to the temperature variation rate in the temperature variation trend parameter increasing at a second rate, determining that the power consumption state of the terminal device during charging is a second power consumption state, where the second rate is lower than the first rate and power consumption of the terminal device in the second power consumption state is lower than power consumption in the first power consumption state; and
in response to the temperature variation rate in the temperature variation trend parameter increasing at a third rate, determining that the power consumption state of the terminal device during charging is a third power consumption state, where the third rate is lower than the second rate and power consumption of the terminal device in the third power consumption state is lower than the power consumption in the second power consumption state.

5. The charging method of claim 4, wherein determining the charging strategy based on the temperature and the power consumption state comprises:
in response to determining that the temperature is within a preset range greater than the first threshold and the terminal device is in the first power consumption state, applying following charging strategy:
first adopting the constant voltage charging mode for charging; and,
when the temperature variation rate of the terminal device is on a downward trend, switching the constant voltage charging mode to the constant current charging mode for charging.

6. The charging method of claim 5, wherein determining the charging strategy based on the temperature and the power consumption state comprises:
in response to determining that the temperature is higher than a maximum value of the preset range and the terminal device is in the first power consumption state, applying following charging strategy:
first decreasing a charging current of the terminal device; and
when the temperature variation rate of the terminal device is on the downward trend, adopting the constant current charging mode for charging.

7. The charging method of claim 5, wherein determining the charging strategy based on the temperature and the power consumption state comprises:
in response to determining that the temperature is higher than a maximum value of the preset range and the terminal device is in the second power consumption state, applying following charging strategy:
first adopting the constant voltage charging mode for charging; and
when the temperature variation rate of the terminal device is on the downward trend and a charging voltage of the terminal device is lower than a maximum charging voltage, switching the constant voltage charging mode to the constant current charging mode for charging; and
when the charging voltage reaches the maximum charging voltage in the constant current charging mode, switching the constant current charging mode to the constant voltage charging mode for charging.

8. The charging method of claim 5, wherein determining the charging strategy based on the temperature and the power consumption state comprises:
in response to determining that the temperature is higher than a maximum value of the preset range and the terminal device is in the third power consumption state, applying following charging strategy:
adopting the constant current charging mode for charging when a charging voltage of the terminal device is lower than a maximum charging voltage; and
adopting the constant voltage charging mode for charging when the charging voltage of the terminal device reaches the maximum charging voltage.

9. The charging method of claim 1, wherein the charging strategy further comprises a charging parameter corresponding to the charging mode.

10. A charging device, comprising:
at least one processor; and
a memory configured to store instructions executable by the at least one processor,
wherein the at least one processor is configured to obtain a temperature and a temperature variation trend parameter of a terminal device, where the temperature variation trend parameter comprises at least one of a temperature variation direction or a temperature variation rate;
determine a charging strategy for the terminal device based on at least one of the temperature or the temperature variation trend parameter, where the charging strategy at least comprises a charging mode and the charging mode comprises at least one of a constant current charging mode or a constant voltage charging mode; and
instruct the terminal device to charge according to the charging strategy.

11. The charging device of claim 10, wherein the at least one processor is further configured to:
in response to determining that the temperature is lower than a first threshold, determine the charging strategy for the terminal device as adoption of the constant current charging mode for charging; and
in response to determining that the temperature is higher than or equal to the first threshold, determine the charging strategy based on the temperature and the temperature variation trend parameter.

12. The charging device of claim 11, wherein the at least one processor is further configured to:
determine a power consumption state of the terminal device during charging based on the temperature variation trend parameter; and
determine the charging strategy based on the temperature and the power consumption state.

13. The charging device of claim 12, wherein the at least one processor is further configured to:
in response to determining that the temperature variation rate in the temperature variation trend parameter increases at a first rate, determine that the power consumption state of the terminal device during charging is a first power consumption state,
in response to determining that the temperature variation rate in the temperature variation trend parameter increases at a second rate, determine that the power consumption state of the terminal device during charging is a second power consumption state, where the second rate is lower than the first rate and power consumption of the terminal device in the second power consumption state is lower than power consumption in the first power consumption state, and
in response to determining that the temperature variation rate in the temperature variation trend parameter increases at a third rate, determine that the power consumption state of the terminal device during charging is a third power consumption state, where the third rate is lower than the second rate and power consumption of the terminal device in the third power consumption state is lower than the power consumption in the second power consumption state.

14. The charging device of claim 13, wherein the at least one processor is further configured to, in response to determining that the temperature is within a preset range greater than the first threshold and the terminal device is in the first power consumption state, determine the charging strategy as first adopting the constant voltage charging mode for charging and, when the temperature variation rate of the terminal device is on a downward trend, switching the constant voltage charging mode to the constant current charging mode for charging.

15. The charging device of claim 13, wherein the at least one processor is further configured to, in response to determining that the temperature is higher than a maximum value of a preset range and the terminal device is in the first power consumption state, determine the charging strategy as first decreasing a charging current of the terminal device and, when the temperature variation rate of the terminal device is on a downward trend, adopting the constant current charging mode for charging.

16. The charging device of claim 13, wherein the at least one processor is further configured to, in response to determining that the temperature is higher than a maximum value of a preset range and the terminal device is in the second power consumption state, determine the charging strategy as first adopting the constant voltage charging mode for charging and, when the temperature variation rate of the terminal device is on a downward trend and a charging voltage of the terminal device is lower than a maximum charging voltage, switching the constant voltage charging mode to the constant current charging mode for charging and then, when the charging voltage reaches the maximum charging voltage in the constant current charging mode, switching the constant current charging mode to the constant voltage charging mode for charging.

17. The charging device of claim 13, wherein the at least one processor is further configured to, in response to determining that the temperature is higher than a maximum value of a preset range and the terminal device is in the third power consumption state, determine the charging strategy as first adopting the constant current charging mode for charging when a charging voltage of the terminal device is lower than a maximum charging voltage, and adopting the constant voltage charging mode for charging when the charging voltage of the terminal device reaches the maximum charging voltage.

18. The charging device of claim 10, wherein the charging strategy further comprises a charging parameter corresponding to the charging mode.

19. A non-transitory computer-readable storage medium, having instructions stored thereon that, when executed by a processor of a terminal device, enable the terminal device to implement the charging method according to claim 1.

20. A terminal device comprising:
a charging device; and
a screen, configured to indicate a progress of charging the terminal device by the charging device;
wherein the charging device comprises:
at least one processor; and
a memory configured to store instructions executable by the at least one processor,
wherein the at least one processor is configured to obtain a temperature and a temperature variation trend parameter of the terminal device, where the temperature variation trend parameter comprises at least one of a temperature variation direction or a temperature variation rate;
determine a charging strategy for the terminal device based on at least one of the temperature or the temperature variation trend parameter, where the charging strategy at least comprises a charging mode and the charging mode comprises at least one of a constant current charging mode or a constant voltage charging mode; and
instruct the terminal device to charge according to the charging strategy.
